(19) United States
(12) Patent Application Publication
(10) Pub. No.: US 2009/0318617 A1
(43) Pub. Date: Dec. 24, 2009

(54) POLYMER DISPERSIONS COMPRISING EFFECT SUBSTANCES AND USE THEREOF

(75) Inventors: Rainer Dyllick-Brenzinger, Neustadt (DE); Alban Glaser, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/281,154

(22) PCT Filed: Mar. 9, 2007
(86) PCT No.: PCT/EP07/52218

§ 371 Date: Aug. 29, 2008

(30) Foreign Application Priority Data
Mar. 16, 2006 (EP) 06111242.1

(51) Int. Cl. C08K 5/132; C08F 2/44; C08L 33/20; C08L 33/08; C08L 25/04

(52) U.S. Cl. 524/740; 524/849; 524/850; 524/853; 524/855

(57) ABSTRACT

Aqueous polymer dispersions, the dispersed particles of which comprise at least one effect substance from the group consisting of UV absorbers, antistatics, antioxidants and antifogging agents and have a mean particle size of at most 500 nm and a glass transition temperature of at least 85° C. and which can be obtained by emulsion polymerization of ethylenically unsaturated monomers in the presence of at least one effect substance, and to the use of the polymer dispersions comprising effect substances or of the polymer powders obtained therefrom for the finishing and for the stabilizing of polymers, in particular for the stabilizing of thermoplastic polymers, against the effect of UV radiation.

The invention relates to aqueous polymer dispersions, the dispersed particles of which comprise at least one effect substance from the group consisting of UV absorbers, antistatics, antioxidants and antifogging agents and have a mean particle size of at most 500 nm and which can be obtained by emulsion polymerization of ethylenically unsaturated monomers in the presence of at least one of the effect substances, and to the use of the polymer dispersions comprising effect substances or of the polymer powders obtained therefrom for the finishing and/or stabilizing of thermoplastic polymers, in particular for stabilizing against the effect of UV radiation.

Use is made of, e.g., “UV absorbers” for the protection of materials such as polymers against the effect of UV rays. In applying the UV absorbers, it is necessary to distribute a small amount of the active substance as evenly as possible in a large amount of a polymer or on a large area of a substance. UV absorbers are lipophilic and, accordingly, virtually insoluble in water. Generally, less than 5 g/l of the active substance dissolves at 23° C. and 1013 mbar. In order, however, to use them in accordance with the desired purpose, they have to be present in finely divided form. There are various methods for this.

For example, a UV absorber is incorporated in a polymer by melting a polymer and mixing the melt, under the action of shear forces, with a formulation comprising the UV absorber. Thus, it is possible, for example, to use for this a dilute aqueous polymer dispersion, the polymers of which comprise a UV absorber. In this connection, the dispersions are generally shortly before use diluted with water to the respective concentration used. The dispersions always comprise a dispersion stabilizer which stabilizes the per se metastable systems. Aqueous polymer dispersions, the dispersed particles of which comprise a UV absorber, can be prepared, for example, according to two different polymerization processes, namely according to the emulsion polymerization process or the miniemulsion polymerization process.

Thus, aqueous polymer dispersions comprising functional substances, such as, in particular, UV absorbers or epoxide resins, are known, e.g., from JP-A 7-292009. They are prepared by dissolution of the functional substances in an unsaturated monomer, emulsification of this solution in water in the presence of a surface-active agent, to give a monomer emulsion with average particle sizes between 5 and 500 nm, and polymerization of the miniemulsion in the presence of a radical initiator. The aqueous dispersions comprising the functional substances, such as UV absorbers, epoxide resins, acrylic-based polymers, phenolic resins, unsaturated polyesters, phenol-based substances and petroleum resins, are used as binders and as additive for protective coating films.

WO 99/40123 discloses a process for the preparation of aqueous polymer dispersions, the dispersed polymer particles of which comprise an organic colorant which is homogenously distributed, i.e. molecularly dispersed. Such aqueous dispersions are prepared by miniemulsion polymerization by polymerizing ethylenically unsaturated monomers, which comprise a dissolved organic colorant, in the form of an oil-in-water emulsion in the presence of radical-forming polymerization initiators, the disperse phase of the miniemulsion being essentially composed of colorant-comprising monomer droplets with a diameter <500 nm. In an advantageous embodiment of the invention, use is made, in the polymerization, of monomer mixtures comprising monomers with a crosslinking effect. The polymer dispersions are stable toward sedimentation. The dispersed particles have a mean particle diameter of 100 to 400 nm. They can be isolated from the aqueous dispersions using conventional drying methods. The colorant-comprising polymer dispersions are used, for example, for the pigmenting of high molecular weight organic and inorganic materials and for the pigmenting of printing inks and of inks for inkjet printing.

U.S. Pat. No. 3,400,093 discloses a process for the preparation of an insecticide-comprising polymer latex or polymer in which a solution of a virtually water-insoluble insecticide in at least one vinyl monomer is emulsified in an aqueous solution comprising at least one surfactant, and this mixture is subsequently subjected to emulsion polymerization.

According to the process known from EP-A 875 544, polymer dispersions comprising UV absorbers, for example, can be prepared by dissolving at least one UV absorber in at least one ethylenically unsaturated monomer and subsequently subjecting the solution to emulsion polymerization in water comprising a polymerization initiator and an emulsifier. The polymer particles can be synthesized from a single polymer or can have a core/shell structure, it being possible for the UV absorber to be either in the core or in the shell of the polymer particle or both in the core and in the shell. The glass transition temperature of the finely divided polymers is preferably 30° C. or lower.

WO 01/10936 discloses particles with a core/shell structure in which the core comprises a polymer with a glass transition temperature T_{g} of less than 40° C. and a copolymerized UV absorber. The monomer composition forming the core essentially comprises ethyl acrylate, a UV absorber comprising, if appropriate, a (meth)acrylate functional, group, and if appropriate, a crosslinking agent. The shell preferably comprises a polymer of ethyl acrylate and/or methyl methacrylate. The polymer particles comprising a UV absorber are prepared by a two-stage emulsion polymerization. They have a mean particle diameter of 40 to 200 nm and are used for the preparation of UV absorbing polymer compositions.

DE-A 102 54 548 discloses the use of finely divided polymer powders comprising at least one UV absorber for the stabilization of polymers against the effect of UV radiation. The polymer particles of the polymer powders have a particle diameter of 500 nm or less. They are prepared by miniemulsion polymerization according to a process disclosed in the abovementioned WO 99/40123. The polymer particles comprise 0.5 to 50% by weight of at least one UV absorber which either is present therein homogeneously distributed in molecular or nanocrystalline form or, however, is completely or only partially coated therein by the polymer matrix.

WO 05/087816 discloses aqueous polymer dispersions comprising effect substances with a mean particle diameter of the dispersed particles of <500 nm, the polymer particles comprising, as core, a polymer matrix synthesized from at least one ethylenically unsaturated monomer, on the surface of which is at least partially disposed an effect substance which is soluble in the monomers forming the polymer matrix of the particles. These polymer dispersions are prepared by emulsifying a solution of an effect substance in at least one ethylenically unsaturated monomer in the presence of at least one surface-active agent in water to give a miniemulsion and polymerizing the monomers in the presence of a radical polymerization initiator in such a way that at first only at most 50% of the monomers present in the polymerization region polymerize and the effect substances migrate to the surface of the emulsified particles, and the polymerization is only brought to an end after extensive or complete accumulation of the effect substances on the surface of the polymer particles produced. Subsequent to the miniemulsion polymerization, a conventional emulsion polymerization of neutral ethylenically unsaturated monomers is carried out in the dispersion obtained by miniemulsion polymerization. Examples of suitable effect substances are UV absorbers, stabilizers for organic polymers, organic colorants, flame retardants, alkenylsuccinic acid anhydrides, alkyl diketenes, pharmaceutical active substances, biocides and optical brighteners.

WO 2006/015791 discloses a process for the preparation of aqueous active substance compositions from sparingly water-soluble active substances. The process comprises the following stages:
a) preparation of an aqueous suspension of solid active substance particles of at least one active substance with a solubility in water of not more than 5 g/l at 25° C./1013 mbar comprising at least one surface-active substance for the stabilization of the dispersed active substance particles, the active substance particles exhibiting, in the suspension, a mean particle size of not more than 1200 nm determined by dynamic light scattering,
b) emulsion polymerization of a first monomer composition M1 in the aqueous suspension of the active substance, the monomer composition M1 comprising at least 95% by weight, based on its total weight, of at least one neutral monoethylenically unsaturated monomer M1.1 with a solubility in water of not more than 30 g/l at 25° C./1013 mbar, by which an aqueous dispersion of polymer/active substance particles is obtained, and
c) emulsion polymerization of a second monomer composition M2 in an aqueous dispersion of the polymer/active substance particles obtained in stage b), the monomer composition M2 comprising at least 60% by weight, based on its total weight, of at least one neutral monoethylenically unsaturated monomer M2.1 with a solubility in water of not more than 30 g/l at 25° C./1013 mbar.

The term “active substances” is understood to mean in this connection substances which give rise to a physiological reaction in an organism even at low concentration. They are preferably active substances for plant protection and for material protection, e.g., herbicides, fungicides, insecticides, acaricides, nematicides, bactericides, growth regulators and other biocides.

It is an object of the invention to make available additional dispersions comprising water-insoluble effect substances.

The object is achieved according to the invention with aqueous polymer dispersions, the dispersed particles of which comprise at least one effect substance from the group consisting of UV absorbers, antistatics, antioxidants and antifogging agents and have a mean particle size of at most 500 nm and which can be obtained by emulsion polymerization of ethylenically unsaturated monomers in the presence of at least one effect substance, if the matrix polymers of the dispersed particles have a glass transition temperature of at least 85° C.

The dispersed polymer particles can be individual particles or, preferably, those particles exhibiting a core/shell structure and in which the matrix polymers have a glass transition temperature T_{g} of at least 95° C. and comprise at least one effect substance, preferably a nonpolymerizable UV absorber, in the core, in the shell or in the core and in the shell. The particles can also comprise several shells, for example 2 to 5 shells. Particular preference is given to dispersed polymer particles exhibiting a core/shell structure and comprising at least one UV absorber in the polymer matrix of the core. The polymer matrix of the dispersed individual particles of the dispersion and the polymer matrix forming the core of the polymer particles with a core/shell structure is preferably crosslinked.

The crosslinked polymer is preferably synthesized from at least one monomer from the group consisting of
(i) C₁-C₁₀-alkyl acrylates, C₁-C₁₀-alkyl methacrylates, styrene, acrylonitrile and methacrylonitrile, and
(ii) at least one crosslinking agent from the group consisting of allyl acrylate, allyl methacrylate, pentaerythritol triacrylate, pentaerythritol tetraacrylate, pentaerythritol trimethacrylate, pentaerythritol tetramethacrylate, ethylene glycol diacrylate, ethylene glycol dimethacrylate, butanediol diacrylate, butanediol dimethacrylate, trimethylolpropane triacrylate, trimethylolpropane trimethacrylate, butadiene, divinylbenzene, divinylurea and methylenebisacrylamide.

The suitable effect substances are generally used in unmodified form as additive for organic polymers, in order to provide the polymers, for example, with an antistatic or antifogging finish or in order to stabilize them against oxidation, effect of UV rays, heat and/or light. Such stabilizers are commercial products. Thus, for example, UV absorbers are sold under the Uvinul® brand by BASF Aktiengesellschaft, Ludwigshafen, Germany. The suitable UV absorbers have, for example, a solubility in water of at most 5 g/l (determined at 25° C. and 1013 mbar) and are soluble in the monomers forming polymers with a glass transition temperature of at least 85° C.

The term “UV absorbers” is understood to mean compounds known to absorb UV rays which deactivate the absorbed radiation in nonradiative fashion. UV absorbers absorb light of the wavelength <400 nm and convert it into thermal radiation. Such compounds are used, for example, in sunscreens and for stabilizing organic polymers. Examples of UV absorbers are derivatives of p-aminobenzoic acid, in particular the esters thereof, e.g. ethyl 4-aminobenzoate and ethoxylated ethyl 4-aminobenzoate, salicylates, substituted cinnamates), such as octyl p-methoxycinnamate or 4-isopentyl 4-methoxycinnamate, 2-phenylbenzimidazole-5-sulfonic acid and their salts. A UV absorber which is particularly preferably used is 4-(n-octyloxy)-2-hydroxybenzo-phenone. Additional examples of UV absorbers are:

substituted acrylates, such as, e.g., ethyl or isooctyl α-cyano-β,β-diphenyl acrylate (principally 2-ethylhexyl α-cyano-β,β-diphenyl acrylate), methyl α-methoxycarbonyl-β-phenyl acrylate, methyl α-methoxycarbonyl-β-(p-methoxyphenyl) acrylate, methyl or butyl α-cyano-β-methyl-β-(p-methoxyphenyl) acrylate, N-(β-methoxycarbonyl-β-cyanovinyl)-2-methylindoline, octyl-p-methoxycinnamate, isopentyl-4-methoxycinnamate, urocanic acid and the salts and esters thereof;

2-hydroxybenzophenone derivatives, such as, e.g., 4-hydroxy-, 4-methoxy-, 4-octyloxy-, 4-decyloxy-, 4-dodecyloxy-, 4-benzyloxy-, 4,2′,4′-trihydroxy-, 2′-hydroxy-4,4′-dimethoxy-2-hydroxybenzophenone, and 4-methoxy-2-hydroxybenzophenone-sulfonic acid, sodium salt;

esters of 4,4-diphenylbutadiene-1,1-dicarboxylic acid, such as, e.g., the bis(2-ethylhexyl) ester;

2-phenylbenzimidazole-4-sulfonic acid and 2-phenylbenzimidazole-5-sulfonic acid, and the salts thereof;

benzoxazole derivatives;

benzotriazole and 2-(2′-hydroxyphenyl)benzotriazole derivatives, such as, e.g., 2-(2H-benzotriazol-2-yl)-4-methyl-6-(2-methyl-3-(1,1,3,3-tetramethyl-1-(trimethylsilyloxy)disiloxanyl)propyl)phenol, 2-(2′-hydroxy-5′-methylphenyl)-benzotriazole, 2-(3′,5′-di(tert-butyl)-2′-hydroxyphenyl)benzotriazole, 2-(5′-(tert-butyl)-2′-hydroxyphenyl)benzotriazole, 2-[2′-hydroxy-5′-(1,1 ,3,3-tetramethylbutyl)phenyl]-benzotriazole, 2-(3′,5′-di(tert-butyl)-2′-hydroxyphenyl)-5-chlorobenzotriazole, 2-(3′-(tert-butyl)-2′-hydroxy-5-methylphenyl)-5-chlorobenzotriazole, 2-(3′-(sec-butyl)-5′-(tert-butyl)-2′-hydroxyphenyl)benzotriazole, 2-(2′-hydroxy-4′-octyloxyphenyl)-benzotriazole, 2-(3′,5′-di(tert-amyl)-2′-hydroxyphenyl)benzotriazole, 2-[3′,5′-bis(α,α-dimethylbenzyl)-2′-hydroxyphenyl]benzotriazole, 2-[3′-(tert-butyl)-2′-hydroxy-5′-(2-octyloxycarbonylethyl)phenyl]-5-chlorobenzotriazole, 2-[3′-(tert-butyl)-5′-(2-(2-ethylhexyloxycarbonyl)ethyl)-2′-hydroxyphenyl]-5-chlorbenzotriazole, 2-[3′-(tert-butyl)-2′-hydroxy-5′-(2-methoxycarbonylethyl)phenyl]-5-chlorobenzotriazole, 2-[3′-(tert-butyl)-2′-hydroxy-5′-(2-methoxycarbonylethyl)phenyl]benzotriazole, 2-[3′-(tert-butyl)-2′-hydroxy-5′-(2-octyloxycarbonylethyl)phenyl]benzotriazole, 2-[3′-(tert-butyl)-5′-(2-(2-ethylhexyloxycarbonyl)ethyl)-2′-hydroxyphenyl]benzotriazole, 2-(3′-dodecyl-2′-hydroxy-5′-methylphenyl)benzotriazole, 2-[3′-(tert-butyl)-2′-hydroxy-5′-(2-isooctyloxycarbonylethyl)phenyl]benzotriazole, 2,2′-methylenebis[4-(1,1,3,3-tetramethylbutyl)-6-(benzotriazol-2-yl)phenol], the completely esterified product of 2-[3′-(tert-butyl)-5′-(2-methoxycarbonylethyl)-2′-hydroxyphenyl]-2H-benzotriazole with polyethylene glycol 300, [R—CH₂CH₂—COO(CH₂)₃—]₂ with R representing 3′-(tert-butyl)-4-hydroxy-5′-(2H-benzotriazol-2-yl)phenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole; benzylidenecamphor and its derivatives, such as those mentioned, e.g., in DE-A 38 36 630, e.g. 3-benzylidenecamphor, 3-(4′-methylbenzylidene)-dl-camphor;

α-(2-oxoborn-3-ylidene)toluene-4-sulfonic acid and its salts, N,N,N-trimethyl-4-(2-oxoborn-3-ylidenemethyl)anilinium methyl sulfate;

dibenzoylmethanes, such as, e.g., 4-(tert-butyl)-4′-methoxydibenzoylmethane;

2,4,6-triaryltriazine compounds, such as 2,4,6-tris{N-[4-(2-ethylhex-1-yloxycarbonyl)-phenyl]amino}-1,3,5-triazine, 4,4′-((6-(((tert-butyl)aminocarbonyl)phenylamino)-1,3,5-triazin-2,4-diyl)imino)bis(benzoic acid 2′-ethylhexylester); and

2-(2-hydroxyphenyl)-1,3,5-triazines, such as, e.g., 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

Additional suitable UV absorbers can be taken from the document Cosmetic Legislation, Vol. 1, Cosmetic Products, European Commission, 1999, pp. 64-66, to which reference is made herewith.

In addition, suitable UV absorbers are disclosed on lines 14 to 30 of page 6 of EP-A 1 191 041. Use is preferably made of nonpolymerizable UV absorbers. However, it is also possible to use UV absorbers exhibiting, for example, an acryl or methacryl group. Such UV absorbers are polymerizable. Examples thereof can be taken from the abovementioned EP-A 875 544, page 10 to page 16, line 47, and from WO 01/10936.

In addition, stabilizers and auxiliaries for organic polymers, in particular thermoplastic polymers, are suitable as effect substances. Stabilizers are compounds which stabilize polymers against decomposition under the action of oxygen, light or heat. They are also described as antioxidants or as UV and light stabilizers, cf. Ullmann's, Encyclopedia of Industrial Chemistry, vol. 3, 629-650 (ISBN-3-527-30385-5), and EP-A 1 110 999, page 2, line 29, to page 38, line 29. Virtually all organic polymers can be stabilized with such stabilizers, cf. EP-A 1 110 999, page 38, line 30 to page 41, line 35. These literature references are made part of the disclosure content of the present invention by reference. The stabilizers disclosed in the EP application belong to the compound category of the pyrazolones, of the organic phosphites or phosphonites, of the sterically hindered phenols and of the sterically hindered amines (stabilizers of the “HALS” type, cf. Römpp, 10th edition, volume 5, pages 4206-4207).

The term “auxiliaries for polymers” is to be understood as meaning, for example, substances which to at least a large extent prevent the fogging of films and moldings made of plastics, i.e. antifogging agents. Commercial stabilizers and auxiliaries are sold under the Tinuvin® and Cyasorb® brands by Ciba and the Tenox® brand by Eastman Kodak. Stabilizers and auxiliaries are described, for example, in Plastics Additives Handbook, 5th edition, Hanser Verlag, ISBN 1-56990-295-X. The stabilizers and auxiliaries are soluble in ethylenically unsaturated monomers, at least 1 g/l, preferably at least 10 g/l, being dissolved at a temperature of 25° C. and a pressure of 1013 mbar.

The aqueous polymer dispersions, the dispersed particles of which comprise at least one effect substance from the group consisting of UV absorbers, antistatics, antioxidants and antifogging agents and have a mean particle size of at most 500 nm, can be obtained by emulsion polymerization of ethylenically unsaturated monomers in the presence of at least one UV absorber, by
(a) dissolving at least one effect substance from the group consisting of UV absorbers, antistatics, antioxidants and antifogging agents, which effect substance exhibits a solubility in water of at most 5 g/l (determined at 25° C. and 1013 mbar), in a monomer composition which forms polymers with a T_{g} of at least 85° C., and
(b) subjecting the monomer solution prepared in step (a) to an emulsion polymerization in the presence of a dispersion stabilizer.

The particle size of the dispersed particles is less than 500 nm, for example ranges from 50 to 300 nm, preferably 80 to 250 nm. They have a glass transition temperature of at least 85° C. According to Fox (T. G. Fox, Bull. Am. Phys. Soc., (Ser. II) 1, 123 [1956], and Ullmanns Enzyklopädie der technischen Chemie [Ullmann's Encyclopedia of Industrial Chemistry], Weinheim (1980), pp. 17-18), the following equation is valid, to a good approximation, for the glass transition temperature of noncrosslinked or weakly crosslinked mixed polymers with high molar masses

$$\frac{1}{{T}_{g}} = \frac{{X}^{1}}{{T}_{g}^{1}} + \frac{{X}^{2}}{{T}_{g}^{2}} + … \frac{{X}^{n}}{{T}_{g}^{n}}$$

in which X¹, X², . . . , Xⁿ represent the weight fractions of the monomers 1, 2, . . . , n and T_{g}¹, T_{g}², . . . , T_{g}ⁿ represent the glass transition temperatures in degrees Kelvin of the polymers in each case synthesized only from one of the monomers 1, 2, . . . , n. The latter polymers are known, e.g., from Ullmann's Encyclopedia of Industrial Chemistry, VCH, Weinheim, Vol. A 21 (1992), pp. 169, or from J. Brandrup and E. H. Immergut, Polymer Handbook, 3rd ed., J. Wiley, New York 1989.

In addition, the term “glass transition temperature T_{g}” is to be understood as meaning the midpoint temperature determined by Differential Scanning Calorimetry (DSC) according to ASTM D 3418-82 (cf. Ullmann's Encyclopedia of Industrial Chemistry, 5th edition, volume A 21, VCH, Weinheim, 1992, p. 169, and Zosel, Farbe und Lack [Color and Paint], 82 (1976) pp. 125-134; see also DIN 53765).

Polymer particles with core/shell structure can be obtained, for example, by
(a) dissolving at least one effect substance from the group consisting of UV absorbers, antistatics, antioxidants and antifogging agents, which effect substance exhibits a solubility in water of at most 5 g/l (determined at 25° C. and 1013 mbar), in a monomer composition which forms polymers with a T_{g} of at least 85° C.,
(b) subjecting the monomer solution prepared in step (a) to an emulsion polymerization in the presence of a dispersion stabilizer and, subsequently,
(c) subjecting a monomer composition, which forms polymers with a glass transition temperature of at least 85° C., to at least one emulsion polymerization, in the presence of a dispersion stabilizer, in the polymer dispersion obtained in step (b).

The aqueous dispersions thus prepared comprise particles with a core/shell structure, where simply the core comprises at least one effect substance from the group consisting of UV absorbers, antistatics, antioxidants and antifogging agents, preferably a UV absorber. However, it is also possible to prepare dispersions, the dispersed particles of which comprise at least one of the abovementioned effect substances both in the core and in the shell. Such aqueous dispersions can be obtained by
(a) dissolving at least one effect substance from the group consisting of UV absorbers, antistatics, antioxidants and antifogging agents, which effect substance exhibits a solubility in water of at most 5 g/l (determined at 25° C. and 1013 mbar), in a monomer composition which forms a polymer matrix with a T_{g} of at least 85° C.,
(b) subjecting the monomer solution prepared in step (a) to an emulsion polymerization in the presence of a dispersion stabilizer and, subsequently,
(c) subjecting a monomer composition, which forms a polymer matrix with a glass transition temperature of at least 85° C., to at least one emulsion polymerization, in the presence of a dispersion stabilizer and at least one effect substance, in the polymer dispersion obtained in step (b).

With one single emulsion polymerization step according to (c), particles are obtained which consist of a core and of a single shell. If several emulsion polymerizations are carried out one after another with different monomer compositions, particles with core/shell structures are obtained which exhibit several shells, for example 2, 3, 4 or even 5 shells.

These dispersions can comprise particles with a core/shell structure which exhibit the same effect substance both in the polymer matrix of the core and in the shell, in the same or in a different concentration, or which comprise, in the polymer matrix of the core, a different effect substance than in the shell. UV absorbers are preferred effect substances used.

In addition, dispersions can be prepared, the dispersed particles of which exhibit such a core/shell structure, which comprise at least one effect substance only in the shell. Such dispersions can be obtained by
(a) subjecting a monomer composition, which forms a polymer matrix with a glass transition temperature of at least 85° C., to an emulsion polymerization in the presence of a dispersion stabilizer, and, subsequently,
(b) subjecting a solution of at least one effect substance from the group consisting of UV absorbers, antistatics, antioxidants and antifogging agents in a monomer composition, which forms matrix polymers with a glass transition temperature of at least 85° C., to at least one emulsion polymerization, in the presence of a dispersion stabilizer, in the dispersion obtained according to step (a).

After the core of the polymer has been formed, at least one shell is polymerized thereon by carrying out an emulsion polymerization. It is also possible here to carry out a single emulsion polymerization or several emulsion polymerizations one after another, e.g., 2, 3. 4 or 5 polymerization steps, with different monomer compositions or different solutions or effect substances in the monomer compositions. In this way, polymer particles with a core/shell structure are obtained in which the particles comprise at least one shell but can also exhibit several shells, e.g., 2, 3, 4 or 5 shells.

The monomer composition subjected in each case to the emulsion polymerization is chosen so that it gives matrix polymers having a glass transition temperature of at least 85° C., preferably of at least 92° C. This condition applies both to dispersed particles synthesized from a single monomer composition and to particles with a core/shell structure. Suitable monomer compositions consist either of a single monomer or of mixtures of two or more monomers. They can, for example, consist of at least one monomer from the group (i). This group includes, for example:
(i) esters of ethylenically unsaturated C₃- to C₅-carboxylic acids and alcohols with 1 to 10 carbon atoms in the molecule, in particular C₁- to C₁₀-alkyl acrylates and C₁₋ to C₁₀-alkyl methacrylates, styrene, 2-methylstyrene, 4-methylstyrene, p-(tert-butyl)styrene, acrylonitrile and methacrylonitrile.

Preferred monomers from the group (i) are methyl methacrylate, methyl acrylate, ethyl acrylate, n-propyl acrylate, isopropyl acrylate, n-butyl acrylate, sec-butyl acrylate, isobutyl acrylate, tert-butyl acrylate, 2-ethylhexyl acrylate, ethylheptyl acrylate, ethyl methacrylate, propyl methacrylates, n-butyl methacrylate, isobutyl methacrylate, tert-butyl methacrylate and 2-ethylhexyl methacrylate.

Use is made particularly preferably, as monomer composition from the group (i), of methyl methacrylate, styrene and tert-butyl acrylate.

Preferred aqueous polymer dispersions comprising at least one effect substance from the group consisting of UV absorbers, antistatics, antioxidants and antifogging agents comprise crosslinked polymer particles. Such dispersions can, for example, be prepared by polymerizing at least one monomer from the group (i) with at least one crosslinking agent. It is known that crosslinking agents are polymerizable compounds comprising at least two ethylenically unsaturated double bonds. Examples of crosslinking agents can be found in WO 99/40123, page 8, line 22, to page 9, line 39.

Use is preferably made of crosslinking agents belonging to the following group (ii) of the monomer compositions, in fact
(ii) allyl acrylate, allyl methacrylate, pentaerythritol triacrylate, pentaerythritol tetraacrylate, pentaerythritol trimethacrylate, pentaerythritol tetramethacrylate, ethylene glycol diacrylate, ethylene glycol dimethacrylate, butanediol diacrylate, butanediol dimethacrylate, trimethylolpropane triacrylate, trimethylolpropane trimethacrylate, butadiene, divinylbenzene, divinylurea and methylenebisacrylamide. Also suitable are crosslinking agents sold by Sartomer under the following descriptions: CN435, SR454, SR499, SR502, SR593, SR415, SR9019, SR351 M, SR9021, SR9020, SR492, SR368, SR355, SR399,

SR494 and SR399 LV.

Additional monomer compositions preferably used are combinations of
(i) methyl methacrylate, styrene and/or tert-butyl acrylate and
(ii) allyl acrylate, allyl methacrylate, pentaerythritol triacrylate, pentaerythritol tetraacrylate, pentaerythritol trimethacrylate, pentaerythritol tetramethacrylate, trimethylolpropane triacrylate and/or trimethylolpropane trimethacrylate.

The polymers can, if appropriate, be modified by using, in the polymerization, an additional group (iii) of monomers. This group of monomers relates, for example, to monoethylenically unsaturated monomers differing from the monomers of the group (i), such as vinyl acetate, vinyl propionate, N-vinylformamide, acrylamide, methacrylamide, N-vinylimidazole, acrylic acid, methacrylic acid, maleic acid, crotonic acid, itaconic acid, acrylamidomethylpropanesulfonic acid, vinylsulfonic acid, N-vinylpyrrolidone, N-vinylcaprolactam, glycidyl methacrylate, N-methylolacrylamide, 2-hydroxyethyl acrylate, 3-hydroxypropyl acrylate, 4-hydroxybutyl acrylate, 2-dimethylaminoethyl acrylate, as free base, as salt or in quaternized form, dimethylaminoethyl methacrylate, as free base, as salt or in quaternized form, diacetone acrylamide, ureido methacrylate and vinylphosphonic acid. These monomers are used, alone or in combination with one another, in the preparation of the aqueous dispersions from the monomers of the group (i) and, if appropriate, (ii). The amounts of monomers of the group (iii) in the monomer composition are adjusted so that dispersions are produced and so that the glass transition temperature of the polymer matrix produced is at least 85° C.

The polymerization of the monomers is carried out according to the method of an emulsion polymerization, i.e. the monomers to be polymerized are present in the polymer mixture as an aqueous emulsion which is stabilized with at least one dispersion stabilizer (emulsifier). For this, the monomers can be provided in bulk form or in the form of a solution comprising the effect substance, preferably a UV absorber.

The monomers can be introduced into the reactor before the beginning of the polymerization or can be added under polymerization conditions, in one or more portions or continuously, a dispersion stabilizer always having to be present (as is usual in emulsion polymerization). If crosslinked polymers are prepared, it is possible to proceed in such a way that at least one crosslinking agent is metered continuously into the reaction region, either separately from the other monomers or as a mixture with the other monomers. A further alternative form consists in introducing the crosslinking agent stepwise into the reaction region.

Preferably, the monomers are used in an amount that the weight ratio of effect substance to monomers ranges from 10:1 to 1:50, in particular 5:1 to 1:30 and particularly preferably 2:1 to 1:20.

The initiators suitable for the emulsion polymerization are in principle all polymerization initiators suitable and conventionally used for emulsion polymerization which initiate a radical polymerization of ethylenically unsaturated monomers. These include, for example, azo compounds, such as 2,2′-azobisisobutyronitrile, 2,2′-azobis(2-methyl-butyronitrile), 2,2′-azobis[2-methyl-N-(2-hydroxyethyl)propionamide, 1,1′-azobis-(1-cyclohexanecarbonitrile), 2,2′-azobis(2,4-dimethylvaleronitrile), 2,2′-azobis(N,N′-dimethyleneisobutyroamidine)dihydrochloride, and 2,2′-azobis(2-amidinopropane)dihydrochloride, organic or inorganic peroxides, such as diacetyl peroxide, di(tert-butyl) peroxide, diamyl peroxide, dioctanoyl peroxide, didecanoyl peroxide, dilauroyl peroxide, dibenzoyl peroxide, bis(o-toluyl)peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy(2-ethylhexanoate) and diisopropyl peroxydicarbonate, salts of peroxodisulfuric acid and redox initiator systems.

Preferably, a redox initiator system, in particular a redox initiator system comprising, as oxidizing agent, a salt of peroxodisulfuric acid, hydrogen peroxide or an organic peroxide, such as tert-butyl hydroperoxide, is used for the polymerization. The redox initiator systems preferably comprise, as reducing agent, a sulfur compound chosen in particular from sodium hydrogensulfite, sodium hydroxymethanesulfinate and the hydrogen sulfite adduct of acetone. Additional suitable reducing agents are phosphorus-comprising compounds, such as phosphorous acid, hypophosphites and phosphinates, and also hydrazine or hydrazine hydrate and ascorbic acid. Furthermore, redox initiator systems can comprise the addition of small amounts of redox metal salts, such as iron salts, vanadium salts, copper salts, chromium salts or manganese salts, such as, for example, the redox initiator system ascorbic acid/iron(II) sulfate/sodium peroxodisulfate. Particularly preferred redox initiator systems are acetone bisulfite adduct/organic hydroperoxide, such as tert-butyl hydroperoxide, sodium disulfite (Na₂S₂O₅)/organic hydroperoxide, such as tert-butyl hydroperoxide, sodium hydroxymethanesulfinate/organic hydroperoxide, such as tert-butyl hydroperoxide, and ascorbic acid/hydrogen peroxide.

Conventionally, the initiator is used in an amount of 0.02 to 2% by weight and in particular 0.05 to 1.5% by weight, based on the amount of the monomers. The optimum amount of initiator naturally depends on the initiator system used and can be determined by a person skilled in the art using routine experiments. The initiator can be introduced partially or completely into the reaction vessel. Generally, a portion of the amount of initiator is introduced, together with a portion of the monomer emulsion, and the remaining initiator is added continuously or portionwise, together with the monomers but separated therefrom.

Pressure and temperature are of secondary importance in carrying out the polymerization of the monomers. The temperature naturally depends on the initiator system used. The optimal polymerization temperature can be determined by a person skilled in the art with the help of routine experiments. The polymerization temperature usually ranges from 0 to 110° C., frequently from 30 to 95° C. The polymerization is usually carried out under standard pressure or ambient pressure. However, it can also be carried out at elevated pressure, e.g. up to 10 bar, or at reduced pressure, e.g. at 20 to 900 mbar, but generally at >800 mbar. The polymerization time is preferably 1 to 300 minutes, in particular 2 to 90 minutes and particularly preferably 3 to 60 minutes, longer or shorter polymerization times also being possible.

Suitable dispersion stabilizers for stabilizing the emulsion polymers produced are, e.g., surface-active substances in an amount of, for example, up to 15% by weight, e.g. 0.1 to 10% by weight, in particular 0.5 to 5% by weight, in each case based on the monomers to be polymerized. Suitable surface-active substances are, in addition to nonionic surface-active substances in particular, also anionic emulsifiers, e.g. alkyl sulfates, alkylsulfonates, alkylarylsulfonates, alkyl ether sulfates, alkylaryl ether sulfates, sulfosuccinates, such as sulfosuccinic acid hemiester and sulfosuccinic acid diester, and alkyl ether phosphates, and furthermore cationic emulsifiers.

Examples of suitable nonionic surface-active substances are ethoxylated mono-, di- and trialkylphenols (degree of ethoxylation: 3 to 50, alkyl radical: C₃-C₁₂) and ethoxylated fatty alcohols (degree of ethoxylation: 3 to 80; alkyl radical: C₈-C₃₆). Examples of these are the Lutensol® brands from BASF AG or the Triton® brands from Union Carbide. Particularly preferred are ethoxylated linear fatty alcohols of the general formula

n-CₓH₂ₓ₊₁—O(CH₂CH₂O)_{y}—H,

in which x are integers ranging from 10 to 24, preferably ranging from 12 to 20. The variable y preferably represents integers ranging from 5 to 50, particulary preferably 8 to 40. Ethoxylated linear fatty alcohols usually exist as a mixture of different ethoxylated fatty alcohols with a different degree of ethoxylation. In the context of the present invention, the variable y represents the mean value (number-average). Suitable nonionic surface-active substances are furthermore copolymers, in particular block copolymers of ethylene oxide and at least one C₃-C₁₀-alkylene oxide, e.g. triblock copolymers of the formula

RO(CH₂CH₂O)_{y1}—(BO)_{y2}-(A-O)ₘ—(B′O)_{y3}—(CH₂CH₂O)_{y4}R′,

in which m represents 0 or 1, A represents a radical derived from an aliphatic, cycloaliphatic or aromatic diol, e.g. represents ethane-1,2-diyl, propane-1,3-diyl, butane-1,4-diyl, cyclohexane-1,4-diyl, cyclohexane-1,2-diyl or bis(cyclohexyl)methane-4,4′-diyl, B and B′ represent, independently of one another, propane-1,2-diyl, butane-1,2-diyl or phenylethane, y4 represent, independently of one another, a number from 2 to 100 and y2 and y3 represent, independently of one another, a number from 2 to 100, the sum y1+y2+y3+y4 preferably ranging from 20 to 400, which corresponds to a number-average molecular weight in the range from 1000 to 20 000. Preferably, A represents ethane-1,2-diyl, propane-1,3-diyl or butane-1,4-diyl. Preferably, B represents propane-1,2-diyl.

Aside from the nonionic surfactants, anionic and cationic surfactants are also suitable as surface-active substances. They can be used alone or as a mixture. A requirement for this, though, is that they be compatible with one another. This requirement applies, for example, to mixtures from each family of compounds and to mixtures of nonionic and anionic surfactants and mixtures of nonionic and cationic surfactants. Examples of suitable surface-active agents are sodium lauryl sulfate, sodium dodecyl sulfate, sodium hexadecyl sulfate and dioctyl sodium sulfosuccinate. Examples of cationic surfactants are long-chain ammonium compounds.

In addition, condensates of naphthalenesulfonic acid and formaldehyde, amphiphilic polymers or nanoparticles of water-insoluble organic polymers or of water-insoluble inorganic compounds (Pickering effect) are suitable as dispersion stabilizer. Stabilizers of this type are, e.g., nanoscale silicon dioxide and aluminum oxide or synthetic organic nanoparticles, such as crosslinked polyacrylic acid, with a particle size of, for example, 10 to 300 nm.

Amphiphilic polymers with average molar masses M_{w} of, for example, 1000 to 100 000 can also be used as dispersion stabilizer. Examples of amphiphilic polymers are copolymers comprising units of
(a) hydrophobic monoethylenically unsaturated monomers and
(b) monoethylenically unsaturated carboxylic acids, monoethylenically unsaturated sulfonic acids, monoethylenically unsaturated phosphonic acids or the mixtures thereof and/or basic monomers.

Suitable hydrophobic monoethylenically unsaturated monomers
(a) are, for example, styrene, methylstyrene, ethylstyrene, acrylonitrile, methacrylonitrile, C₂- to C₁₈-olefins, esters of monoethylenically unsaturated C₃- to C₅-carboxylic acids and monovalent alcohols, vinyl alkyl ethers, vinyl esters or the mixtures thereof. Use is preferably made, from this group of monomers, of isobutene, diisobutene, styrene and acrylates, such as ethyl acrylate, isopropyl acrylate, n-butyl acrylate and sec-butyl acrylate.

The amphiphilic copolymers comprise, as hydrophilic monomers
(b) preferably acrylic acid, methacrylic acid, maleic acid, maleic anhydride, itaconic acid, vinylsulfonic acid, 2-acrylamidomethylpropanesulfonic acid, acrylamidopropane-3-sulfonic acid, 3-sulfopropyl acrylate, 3-sulfopropyl methacrylate, styrenesulfonic acid, vinylphosphonic acid or the mixtures thereof in copolymerized form. The acidic monomers can be present in the form of the free acids or in partially or completely neutralized form.

Additional suitable hydrophilic monomers are basic monomers. They can be polymerized with the hydrophobic monomers (a) alone or also as a mixture with the abovementioned acidic monomers. If mixtures of basic and acidic monomers are used, amphoteric copolymers are produced which are anionically or cationically charged according to the molar ratio of the acidic to basic monomers copolymerized in each case.

Basic monomers are, for example, di(C₁- to C₂-alkyl)amino(C₂- to C₄-alkyl)(meth)acrylates or diallyldimethylammonium chloride. The basic monomers can be present in the form of the free bases, of the salts with organic or inorganic acids or in the form quaternized with alkyl halides. The salt formation or the quaternizing, by which the basic monomers become cationic, can be carried out partially or completely.

Examples of such compounds are dimethylaminoethyl methacrylate, diethylaminoethyl methacrylate, dimethylaminoethyl acrylate, diethylaminoethyl acrylate, dimethylaminopropyl methacrylate, dimethylaminopropyl acrylate, diethylaminopropyl methacrylate, diethylaminopropyl acrylate and/or dimethylaminoethylacrylamide, dimethylaminoethylmethacrylamide, dimethylaminopropylacrylamide, dimethylaminopropylmethacrylamide and/or diallyidimethylammonium chloride.

If the amphiphilic copolymers in the form of the free acid are not sufficiently soluble in water, they are used in the form of water-soluble salts; e.g., the corresponding alkali metal, alkaline earth metal and ammonium salts are used. These salts are prepared, for example, by partial or complete neutralization of the free acid groups of the amphiphilic copolymers with bases; e.g., sodium hydroxide, potassium hydroxide, magnesium oxide, ammonia or amines, such as triethanolamine, ethanolamine, morpholine, triethylamine or butylamine, are used for the neutralization. Preferably, the acid groups and the amphiphilic copolymers are neutralized with ammonia or sodium hydroxide. On the other hand, the solubility in water of basic monomers or of copolymers comprising such monomers copolymerized can be increased by partial or complete neutralization with an inorganic acid, such as hydrochloric acid or sulfuric acid, or by addition of an organic acid, such as acetic acid or p-toluenesulfonic acid. The molar mass of the amphiphilic copolymers is, for example, 1000 to 100 000 and preferably ranges from 1500 to 10 000. The acid numbers of the amphiphilic copolymers are, for example, 50 to 500, preferably 150 to 350, mg of KOH/g of polymer.

Particularly preferred are those amphiphilic copolymers which comprise, copolymerized,
(a) 95 to 45% by weight of isobutene, diisobutene, styrene or the mixtures thereof and
(b) 5 to 55% by weight of acrylic acid, methacrylic acid, maleic acid, hemiesters of maleic acid or the mixtures thereof.

Use is made particularly preferably, as dispersion stabilizer, of copolymers comprising, copolymerized,
(a) 45 to 80% by weight of styrene,
(b) 55 to 20% by weight of acrylic acid and, if appropriate,
(c) moreover additional monomers.

The copolymers can, if appropriate, comprise, copolymerized, units of maleic acid hemiesters as additional monomers (c). Such copolymers can be obtained, for example, by copolymerizing copolymers of styrene, diisobutene or isobutene or the mixtures thereof with maleic anhydride in the absence of water and, subsequent to the polymerization, reacting the copolymers with alcohols, 5 to 50 mol % of a monovalent alcohol being used per mole of anhydride groups in the copolymer. Suitable alcohols are, for example, methanol, ethanol, n-propanol, isopropanol, n-butanol, isobutanol and tert-butanol. However, it is also possible to react the anhydride groups of the copolymers with polyvalent alcohols, such as glycol or glycerol. In this connection, however, the reaction is carried out only as far as only one OH group of the polyvalent alcohol reacts with the anhydride group. If the anhydride groups of the copolymers are not completely reacted with alcohols, the ring opening of the anhydride groups which have not reacted with alcohols takes place by addition of water.

Other suitable dispersion stabilizers are, for example, standard polymers of monoethylenically unsaturated acids and graft polymers of N-vinylformamide on polyalkylene glycols, which are disclosed, for example, in WO-A-96/34903. The vinylformamide units which have been grafted on can, if appropriate, be hydrolyzed. The proportion of vinylformamide units which have been grafted on is preferably 20 to 40% by weight, based on polyalkylene glycol. Preferably, use is made of polyethylene glycols with molar masses of 2000 to 10 000.

In addition, zwitterionic polyalkylenepolyamines and zwitterionic polyethyleneimines are suitable as dispersion stabilizer. Such compounds are known, for example, from EP-B 112 592. They can, for example, be obtained by first alkoxylating a polyalkylenepolyamine or polyethyleneimine, e.g. with ethylene oxide, propylene oxide and/or butylene oxide, subsequently quaternizing the alkoxylation products, e.g. with methyl bromide or dimethyl sulfate, and then sulfating the quaternized alkoxylated products with chlorosulfonic acid or sulfur trioxide. The molar mass of the zwitterionic polyalkylenepolyamines is, for example, 1000 to 9000, preferably 1500 to 7500. The zwitterionic polyethyleneimines preferably have molar masses ranging from 1500 to 7500 daltons.

Protective colloids are additional suitable dispersion stabilizers. They generally have average molar masses M_{w} of greater than 500, preferably of more than 1000. Examples of protective colloids are poly(vinyl alcohol)s, cellulose derivatives, such as carboxymethylcellulose, polyvinylpyrrolidone, polyethylene glycols, graft polymers of vinyl acetate and/or vinyl propionate on polyethylene glycols, polyethylene glycols closed at one or both ends with alkyl, carboxyl or amino groups, poly(diallyldimethylammonium chloride)s and/or polysaccharides, such as, in particular, water-soluble starches or starch derivatives, and proteins. Such products are described, for example, in Römpp, Chemie Lexikon [Chemistry Lexicon], 9th edition, volume 5, page 3569, or in Houben-Weyl, Methoden der organischen Chemie [Methods of Organic Chemistry], 4th edition, volume 14/2, chapter IV, Umwandlung von Cellulose und Stärke [Conversion of Cellulose and Starch] by E. Husemann and R. Werner, pages 862-915, and in Ullmann's Encyclopedia of Industrial Chemistry, 6th edition, volume 28, pages 533 ff, under Polysaccharides.

All types of water-soluble starch, e.g. both amylose and amylopectin, native starches, hydrophobically or hydrophilically modified starches, anionic starches, cationically modified starches, degraded starches, the starch breakdown being able to be carried out, for example, oxidatively, thermally, hydrolytically or enzymatically, and both native and modified starches being able to be used for the starch breakdown, are suitable, for example. Additional suitable protective colloids are dextrins and crosslinked water-soluble starches which are swellable in water.

Use is preferably made, as protective colloid, of native water-soluble starches which can be converted into a water-soluble form, for example by starch decomposition, and also anionically modified starches, such as oxidized potato starch. Particular preference is given to anionically modified starches which have been subjected to a reduction in molecular weight. The reduction in molecular weight is preferably carried out enzymatically. The average molar mass M_{w} of the degraded starches is, for example, 500 to 100 000, preferably 1000 to 30 000. The degraded starches have, for example, an intrinsic viscosity [η] of 0.04 to 0.5 dl/g. Such starches are, for example, disclosed in EP-B-0 257 412 and in EP-B-0 276 770. If protective colloids are used in the polymerization, the amounts used are, for example, 0.5 to 50% by weight, in particular 5 to 40% by weight, usually 10 to 30% by weight, based on the monomers used in the polymerization.

Naturally, additional additives which are conventional in emulsion polymerization, for example glycols, polyethylene glycols, buffers/pH regulators, molecular weight regulators and chain-transfer inhibitors, can be added to the polymerization mixture.

An aqueous polymer dispersion comprising at least one effect substance is obtained, the effect substances being at least partially coated by the water-insoluble polymer formed from the monomers. No measurable or only extremely low amounts of agglomerates are observed, these generally making up less than 2% by weight, preferably less than 0.2% by weight, based on the solids present in the dispersion.

It is possible, as already explained above, in an additional step, to subject the aqueous polymer dispersions thus obtainable, which comprise at least one effect substance, preferably a kind of UV absorber, if appropriate in an additional processing step, to an additional emulsion polymerization in order to vary the properties of the polymer particles. In this connection, another monomer or another mixture of monomers can be grafted onto the dispersed polymer particles so that particles with a core/shell structure are produced. These particles can comprise a single shell or, if the emulsion polymerization is repeated with another composition or the monomers or of the effect substances, also several shells, e.g., 2, 3, 4 or even 5 different shells. The polymer matrix of the shell of such structures can be noncrosslinked or, preferably, crosslinked. If core/shell polymer particles are prepared, the weight ratio of polymer in the core to polymer in the shell is, for example, 5:1 to 1:5, preferably 2:1 to 1:2.

Polymer powders comprising effect substances can be obtained from the aqueous dispersions described above, which comprise at least one effect substance, preferably a UV absorber, by evaporating the volatile constituents of an aqueous polymer dispersion comprising effect substances. Preferably, such powders are prepared from the dispersions described by spray drying.

The polymer dispersions comprising effect substances or the polymer powders obtained therefrom are used for the finishing and/or stabilizing of polymers, in particular against the effect of UV radiation. They are, for example, incorporated in thermoplastic polymers, such as polyethylene, polypropylene, polyamide, polyacrylonitrile, polycarbonate, poly(vinyl chloride) or polyester. Amounts of polymers comprising effect substances, preferably polymers comprising UV absorbers, for example of 0.1 to 3% by weight, preferably 0.5 to 2% by weight, based on the polymer to be finished, are necessary for this.

In order to stabilize a thermoplastic polymer against the effect of UV, it is possible, for example, to proceed in such a way that the polymer is first melted in an extruder and a powder comprising UV absorber prepared according to the invention is incorporated in the polymer melt at a temperature of, for example, 180 to 200° C., and a granulate is prepared therefrom, from which films are then prepared, according to known processes, which are stabilized against the effect of UV radiation.

### EXAMPLES

The percentage values in the examples represent percentages by weight, unless otherwise evident from the context.

The particle sizes were measured with a Coulter N4 Plus laser diffraction device or alternatively with a Coulter 230 LS. In principle, the measurements were carried out in 0.01% by weight aqueous compositions.

The glass transition temperature T_{g} was determined by Differential Scanning Calorimetry (DSC) according to the instructions of ASTM D 3418-82.

### Example 1

116.3 g of deionized water were introduced into a reactor flushed with N₂ and brought to a pot temperature of 80° C. with stirring. 13.05 g of a mixture of 11.69 g of deionized water and 40.5 g of a 2% sodium peroxodisulfate solution (feed 3) were then added all at once. Subsequently, a mixture of 405.8 g of deionized water, 9.9 g of Dowfax® 2A1 (45% aqueous solution of a surfactant: disodium salt of dodecyidiphenyl ether disulfonic acid), 3.24 g of allyl methacrylate and 173.88 g of methyl methacrylate (feed 1) was added in 3.5 hours. Simultaneously, the remainder of feed 3 was metered into the reaction mixture over a time of 5 hours.

After the end of feed 1, polymerization is carried out for a further 30 min. A mixture of 175 g of deionized water, 0.9 g of Dowfax® 2A1, 92.88 g of methyl methacrylate and 54 g of 4-(n-octyloxy)-2-hydroxybenzophenone (Uvinul 3008), which was dissolved in the monomer, (feed 2) is now metered in in 1 h. A solution of 3.59 g of deionized water and 5.4 g of a 10% aqueous tert-butyl hydroperoxide solution (feed 4) was then added, and also 4.05 g of Rongalit® C (10% aqueous solution of an addition product of sodium hydrogensulfite with formaldehyde) and 4.94 g of deionized water (feed 5), over a period of 60 minutes.

Subsequently, the reaction mixture was allowed to cool to ambient temperature and the dispersion was filtered through a 500 μm and then through a 125 μm filter, in order to remove the coagulate. The amount of the coagulate separated was 5.5 g. The dispersion had a solids content of 28.1% and comprised 333 ppm of residual monomer (methyl methacrylate). The mean particle size was 173 nm. The polymer had a glass transition temperature T_{g} of 93° C.

Under a light microscope, no crystals of the UV absorber could be recognized in the dispersion at 1000 times magnification, i.e. the UV absorber is present in the polymer matrix.

A loose white powder was obtained by spray drying the aqueous dispersion, a Debye-Scherrer powder diagram of which was recorded. The photograph clearly showed that the UV absorber was present in the polymer matrix in the amorphous and noncrystalline form.

### Example 2

116.3 g of deionized water were introduced into a reactor flushed with N₂ and brought to a pot temperature of 80° C. with stirring. 13.05 g of a mixture of 11.69 g of deionized water and 40.5 g of a 2% sodium peroxodisulfate solution (feed 3) were then added all at once. Subsequently, a mixture of 470.09 g of deionized water, 9.9 g of Dowfax® 2A1, 3.24 g of allyl methacrylate, 173.88 g of methyl methacrylate and 54 g of 4-(n-octyloxy)-2-hydroxybenzophenone, which was dissolved in the monomers, (feed 1) was metered in in 3.5 hours. Simultaneously, the remainder of feed 3 was added over a time of 5 hours.

After the end of feed 1, the reaction mixture was polymerized for a further 30 min still. Subsequently, a mixture of 110.7 g of deionized water, 0.9 g of Dowfax® 2A1 and 92.88 g of methyl methacrylate (feed 2) was metered in in 1 hour. A solution of 3.59 g of deionized water and 5.4 g of a 10% aqueous solution of tert-butyl hydroperoxide (feed 4), and also 4.05 g of Rongalit® C and 4.94 g of deionized water (feed 5), were then added over a period of 60 minutes. Subsequently, the reaction mixture was allowed to cool to ambient temperature and the dispersion was filtered through a 500 μm and then through a 125 μm filter, in order to remove the coagulate. The amount of the coagulate separated was 3.2 g or 0.7 g, and the solids content was determined at 30.4%. The mean particle size was 219 nm. The polymer had a glass transition temperature T_{g} of 92° C.

Under a light microscope, no crystals of 4-(n-octyloxy)-2-hydroxybenzophenone could be recognized in the dispersion at 1000 times magnification, i.e. the UV absorber is present in the polymer matrix. The spray drying of the dispersion yielded a white powder.

A Debye-Scherrer powder diagram of the powder was recorded, which diagram clearly showed that the UV absorber was present in the polymer in amorphous and noncrystalline form.

### Example 3

116.3 g of deionized water were introduced into a reactor flushed with N₂ and brought to a pot temperature of 80° C. with stirring. 13.05 g of a mixture of 11.69 g of deionized water and 40.5 g of a 2% sodium peroxodisulfate solution (feed 2) were then added all at once. Subsequently, a mixture of 580.79 g of deionized water, 10.8 g of Dowfax® 2A1, 3.24 g of allyl methacrylate, 266.76 g of methyl methacrylate and 54 g of 4-(n-octyloxy)-2-hydroxybenzophenone (Uvinul 3008), which was dissolved in the monomers, was added in 3.5 hours as feed 1. Simultaneously, the remainder of feed 2 was metered in, likewise over a time of 3.5 hours. After the end of feeds 1 and 2, the reaction mixture was polymerized for a further 30 minutes still. Subsequently, a mixture of 3.59 g of deionized water and 5.4 g of tert-butyl hydroperoxide (feed 3) together with a mixture of 4.05 g of Rongalit® C and 4.94 g of deionized water (feed 4) were metered in in 1 hour.

Afterwards, the reaction mixture was cooled to ambient temperature and the dispersion was filtered through a 500 μm and then through a 125 μm filter, in order to remove the coagulate. The amount of the coagulate separated was 4.1 g (500 μm filter) and 9 g (125 μm filter). The solids content of the dispersion was 28.3%. The mean particle size was 288 nm.

Under a light microscope, no crystals of 4-(n-octyloxy)-2-hydroxybenzophenone could be recognized in the dispersion at 1000 times magnification, i.e. the UV absorber was present in the polymer matrix. The spray drying of the dispersion yielded a white powder. The glass transition temperature of the polymer was determined at 98.1° C.

The change in the particle size and the solids content over time during the preparation of the dispersion is shown in the following table.

| Time [min] | Particle size [nm] | Solids content [%] |
|---|---|---|
| 0 | 0 | 5 |
| 15 | 127 | 10.4 |
| 30 | 154 | 13.7 |
| 45 | 175 | 17.6 |
| 60 | 200 | 19.3 |
| 75 | 210 | 21.9 |
| 90 | 221 | 21.7 |
| 105 | 234 | 23.9 |
| 120 | 242 | 23.7 |
| 135 | 252 | 25.2 |
| 150 | 263 | 26.1 |
| 165 | 274 | 26.4 |
| 180 | 278 | 26.7 |
| 195 | 288 | 27.4 |
| 210 | 304 | 27.8 |
| 240 | 302 | 27.8 |
| after cooling | 288 | 28.3 |

### Example 4

116.3 g of deionized water were introduced into a reactor flushed with N₂ and brought to a pot temperature of 80° C. with stirring. 13.05 g of a mixture of 11.69 g of deionized water and 40.5 g of a 2% sodium peroxodisulfate solution (feed 2) were then added all at once. Subsequently, a mixture of 580.79 g of deionized water, 10.8 g of Dowfax® 2A1, 3.24 g of pentaerythritol tetraacrylate, 266.76 g of methyl methacrylate and 54 g of 4-(n-octyloxy)-2-hydroxybenzophenone, which was dissolved in the monomers, was added in 3.5 hours as feed 1. Simultaneously, the remainder of feed 2 was metered in, likewise over a time of 3.5 hours. After feeds 1 and 2 had been completely metered in, the reaction mixture was stirred for a further 30 minutes still. A mixture of 3.59 g of deionized water and 5.4 g of tert-butyl hydroperoxide (feed 3) together with a mixture of 4.05 g of Rongalit C (feed 4) were then metered in in 1 hour. Subsequently, the mixture was allowed to cool to ambient temperature and the dispersion was filtered, first through a 500 μm and then through a 125 μm filter, in order to remove the coagulate. The amount of the coagulate separated was 1 g or 18 g (125 μm filter); the solids content of the dispersion was determined at 27.2%. The mean particle size of the dispersed particles was 303 nm.

Under a light microscope, no crystals of 4-(n-octyloxy)-2-hydroxybenzophenone could be recognized in the aqueous dispersion at 1000 times magnification, which means that the UV absorber was present in the polymer matrix. The spray drying of the dispersion yielded a white powder. The glass transition temperature T_{g} of the polymer was determined at 104.9° C.

1. An aqueous polymer dispersion, the dispersed particles of which comprise at least one effect substance selected from the group consisting of UV absorbers, antistatics, antioxidants and antifogging agents and have a mean particle size of at most 500 nm and which are obtained by emulsion polymerization of ethylenically unsaturated monomers in the presence of at least one effect substance, wherein the matrix polymers of the dispersed particles have a glass transition temperature of at least 85° C.

2. The aqueous polymer dispersion according to claim 1, wherein the dispersed polymer particles exhibit a core/shell structure and wherein the matrix polymers have a glass transition temperature Tg of at least 95° C. and comprise at least one effect substance in the core, in the shell or in the core and in the shell.

3. The aqueous polymer dispersion according to claim 1, wherein the matrix polymers comprise at least one nonpolymerizable UV absorber.

4. The aqueous polymer dispersion according to claim 1, wherein the dispersed polymer particles exhibit a core/shell structure and comprise at least one UV absorber in the core.

5. The aqueous polymer dispersion according to claim 1, wherein the polymer matrix of the dispersed individual particles of the dispersion or of the core of the polymer particles with a core/shell structure is crosslinked.

6. The aqueous dispersion according to claim 5, wherein the crosslinked polymer is synthesized from at least one monomer selected from the group consisting of
(i) C₁-C₁₀-alkyl acrylates, C₁-C₁₀-alkyl methacrylates, styrene, acrylonitrile and methacrylonitrile, and
(ii) at least one crosslinking agent from the group consisting of allyl acrylate, allyl methacrylate, pentaerythritol triacrylate, pentaerythritol tetraacrylate, pentaerythritol trimethacrylate, pentaerythritol tetramethacrylate, butanediol diacrylate, ethylene glycol diacrylate, ethylene glycol dimethacrylate, butanediol dimethacrylate, trimethylolpropane triacrylate, trimethylolpropane trimethacrylate, butadiene, divinylbenzene, divinylurea and methylenebisacrylamide.

7. The aqueous dispersion according to claim 1, wherein the UV absorber is 4-(n-octyloxy)-2-hydroxybenzophenone.

8. A polymer powder comprising at least one effect substance selected from the group consisting of UV absorbers, antistatics, antioxidants and antifogging agents, which is obtained by evaporation of the volatile constituents of an aqueous polymer dispersion comprising the effect substances according to claim 1.

9. A method of using polymer powders for the finishing and for the stabilizing of organic polymers, said powders comprising at least one effect substance selected from the group consisting of UV absorbers, antistatics, antioxidants and antifogging agents according to claim 1.

10. The method according to claim 9, wherein polymer dispersions comprising UV absorbers or the polymer powders obtained therefrom are used for the stabilizing of thermoplastic polymers against the effect of UV radiation.
